(19) United States
(12) Patent Application Publication
(10) Pub. No.: US 2026/0032597 A1
(43) Pub. Date: Jan. 29, 2026

(54) Always-On Scan Leeching

(71) Applicant: Apple Inc., Cupertino, CA (US)

(72) Inventors: Sameer Thalappil, San Diego, CA (US); Rajneesh Kumar, Los Gatos, CA (US); Shehla S. Rana, San Jose, CA (US); Gagan Jain, Cupertino, CA (US)

(21) Appl. No.: 18/788,115

(22) Filed: Jul. 29, 2024

(51) Int. Cl. H04W 52/02; H04W 48/16

(52) U.S. Cl. CPC H04W 52/028; H04W 48/16

(57) ABSTRACT

A method of providing Wi-Fi access point (AP) information in a user equipment (UE) is disclosed. The method comprises performing a scan by a Wi-Fi radio of the UE to obtain scan results of APs operating adjacent to the UE while the UE operates in a sleep mode with one or more processors of the UE operating in the sleep mode. Sending one or more of the scan results of the APs from the Wi-Fi radio to an always on processor (AOP) of the UE. Storing the scan results in an always on database (AON DB). And accessing the AON DB by the one or more processors of the UE when the UE is not operating in the sleep mode to enable the UE to display information for the one or more of the scan results stored in the AON DB.

### FIELD

Embodiments of the invention relate to wireless communications, including apparatuses, systems, and methods for enabling always-on scan leeching in wireless communication systems.

### DESCRIPTION OF THE RELATED ART

Wireless communication systems are rapidly growing in usage. People now expect to have a continuous connection with the internet regardless of where they are located. To that end, satellite communications networks, cellular communications networks, wireless local area networks, and wireless personal area networks are now ubiquitous.

Mobile electronic devices, or user equipment devices (UEs), may take the form of smart phones or tablets that a user typically carries. With the increased number of networks, an increasing number of different wireless frequency bands are available to UEs. UEs may be configured to switch between different networks as a user moves about. The large number of available networks can complicate network measurement, reporting, and selection. Accordingly, improvements in the field are desired.

### BRIEF DESCRIPTION OF THE DRAWINGS

A better understanding of the present subject matter can be obtained when the following detailed description of various embodiments is considered in conjunction with the following drawings.

FIG. 1 illustrates an example wireless communication system including a user equipment device (UE) according to some embodiments.

FIG. 2A illustrates an example block diagram of a UE (STA), according to some embodiments.

FIG. 2B illustrates an example block diagram of a UE (STA) with Wi-Fi Logic operating on a radio in communication with one or more always on processors (AOP).

FIG. 3 illustrates an example block diagram of a network element or access point, according to some embodiments.

FIG. 4 illustrates an example block diagram of an IEEE 802.11 configuration, according to some embodiments.

FIG. 5A illustrates an example diagram of a mobile user with a UE operating in sleep mode while the user moves between access points (APs) in accordance with some embodiments.

FIG. 5B illustrates an example diagram of a mobile user with a UE operating in sleep mode while the user moves to a second AP in accordance with some embodiments.

FIG. 5C illustrates an example diagram of a mobile user with a UE that is awakened and performs a scan of available APs upon awakening in accordance with some embodiments.

FIG. 6 illustrates an example diagram of a UE configured to display a user interface to show the availability of Wi-Fi networks for a user to select in accordance with some embodiments.

FIG. 7 illustrates an example diagram of a mobile user with a UE that is awakened and obtains Wi-Fi scan information of available APs upon awakening from an always on database on an always on processor in accordance with some embodiments.

FIG. 8 illustrates an example flow chart in which data from a scan engine is communicated to an always on processor AOP1 in accordance with some embodiments.

FIG. 9 illustrates an example diagram illustrating a flow chart for a Wi-Fi user interface (UI) to receive Wi-Fi scan results upon wakeup of the UE, or when the user activates the UI in accordance with some embodiments.

FIG. 10 is a flow chart of an example of a method of performing a scan by a Wi-Fi radio of the UE to obtain scan results of APs operating adjacent to the UE while the UE operates in a sleep mode, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium or Memory-Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element-includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, Internet of Things, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or may be stationary or fixed at a certain location. The terms “station” and “STA” are used similarly. A UE is an example of a wireless device.

Communication Device-any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” or “Access Point” has the full breadth of its ordinary meaning, and at least includes a wireless communication station installed at a fixed location and used to communicate with UEs as part of a wireless communication system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

IEEE 802.11—refers to technology based on the Institute of Electronics and Electrical Engineers (IEEE) 802.11 wireless standards such as 802.11a, 802.11.b, 802.11g, 802.11n (Wi-Fi 4), 802.11-2012, 802.11ac (Wi-Fi 5), 802.11ad, 802.11ax (Wi-Fi 6 and 6E), 802.11ay, 802.11be (Wi-Fi 7), 802.11bn (Wi-Fi 8) and/or other IEEE 802.11 standards. IEEE 802.11 technology may also be referred to as “Wi-Fi” or “wireless local area network (WLAN)” technology.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, 3GPP LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, such as Wi-Fi, WLAN channels may be 22 MHz wide, while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Scan leeching—scanning for Wi-Fi signals of Wi-Fi access points (AP).

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

The example embodiments may be further understood with reference to the following description and the related appended drawings, wherein like elements are provided with the same reference numerals. The example embodiments relate to apparatuses, systems and methods for reducing energy usage by network components, e.g., base stations in wireless communication systems.

The example embodiments are described with regard to communication between a wireless Access Pointe (AP) and a user equipment (UE). However, reference to an AP or a UE is merely provided for illustrative purposes. The example embodiments may be utilized with any electronic component that may establish a connection to a network and is configured with the hardware, software, and/or firmware to support for reducing energy usage by network components in wireless communication systems. Therefore, the AP or UE as described herein is used to represent any appropriate type of electronic component.

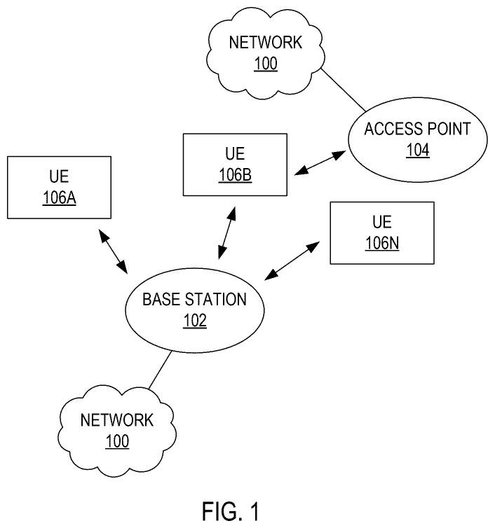

### FIGS. 1: Wireless Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a cellular base station 102 which communicates over a transmission medium with one or more user devices 106A, 106B, etc., through user device 106N. Each of the user devices may be referred to herein as a “user equipment” (UE). Thus, the user devices 106 are referred to as UEs or UE devices.

The UE 106 may be a device with wireless network connectivity such as a mobile phone, a hand-held device, a laptop, a wearable device, a computer or a tablet, an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The base station (BS) 102 may be a base transceiver station (BTS) or cell site (a “cellular base station”) and may include hardware that enables wireless communication with the UEs 106A through 106N. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the UE devices 106 and/or between the UE devices 106 and the network 100. In other implementations, base station 102 can be configured to provide communications over one or more other wireless technologies, such as an access point (AP) 104 supporting one or more WLAN protocols, such as 802.11 a, b, g, n, ac, ad, ay, be, bn and/or ax, or LTE in an unlicensed band (LAA).

The communication area (or coverage area) of the base station may be referred to as a “cell.” The base station 102 and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), Wi-Fi, etc.

Base station 102 and other similar base stations (not shown) operating according to one or more cellular communication technologies may thus be provided as a network of cells, which may provide continuous or nearly continuous overlapping service to UE devices 106A-N and similar devices over a geographic area via one or more cellular communication technologies.

Note that at least in some instances a UE device 106 may be capable of communicating using any of multiple wireless communication technologies. For example, a UE device 106 might be configured to communicate using one or more of GSM, UMTS, CDMA2000, LTE, LTE-A, 5G NR, WLAN, Bluetooth, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances a UE device 106 may be configured to communicate using only a single wireless communication technology.

As shown, the exemplary wireless communication system also includes a wireless local area network (WLAN) access point (AP) 104, which communicates over a transmission medium with the wireless device 106B. The WLAN access point, which may be a Wi-Fi AP, also provides communicative connectivity to the network 100. Thus, according to some embodiments, wireless devices may be able to connect to either or both of the base station 102 (or another cellular base station) and the access point 104 (or another access point) to access the network 100 at a given time.

The UEs 106A and 106B may include handheld devices such as smart phones or tablets, wearable devices such as smart watches or smart glasses, and/or may include any of various types of devices with cellular communications capability. For example, one or more of the UEs 106A and 106B may be a wireless device intended for stationary or nomadic deployment such as an appliance, measurement device, control device, etc.

The UE 106B may also be configured to communicate with the UE 106A. For example, the UE 106A and UE 106B may be capable of performing direct device-to-device (D2D) communication. The D2D communication may be supported by the cellular base station 102 (e.g., the BS 102 may facilitate discovery, among various possible forms of assistance), or may be performed in a manner unsupported by the BS 102.

The UE 106 may include one or more devices or integrated circuits for facilitating wireless communication, potentially including a cellular modem and/or one or more other wireless modems. The wireless modem(s) may include one or more processors (processor elements) and various hardware components as described herein. The UE 106 may perform any of the method embodiments described herein by executing instructions on one or more programmable processors. Alternatively, or in addition, the one or more processors may be one or more programmable hardware elements such as an FPGA (field-programmable gate array), or other circuitry, which is configured to perform any of the method embodiments described herein, or any portion of any of the method embodiments described herein. The wireless modem(s) described herein may be used in a UE device as defined herein, a wireless device as defined herein, or a communication device as defined herein. The wireless modem described herein may also be used in a base station or other similar network side device.

The UE 106 may include one or more antennas for communicating using one or more wireless communication protocols or radio access technologies. In some embodiments, the UE device 106 might be configured to communicate using a single shared radio. The shared radio may couple to a single antenna, or may couple to multiple antennas (e.g., for MIMO) for performing wireless communications. Alternatively, the UE device 106 may include two or more radios, each of which may be configured to communicate via a respective wireless link. Other configurations are also possible.

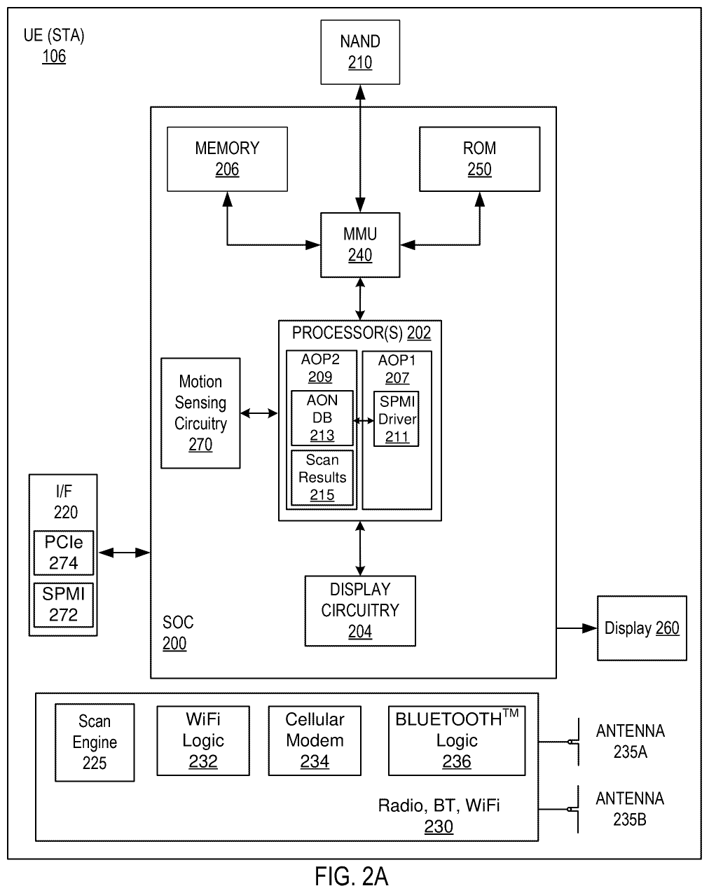

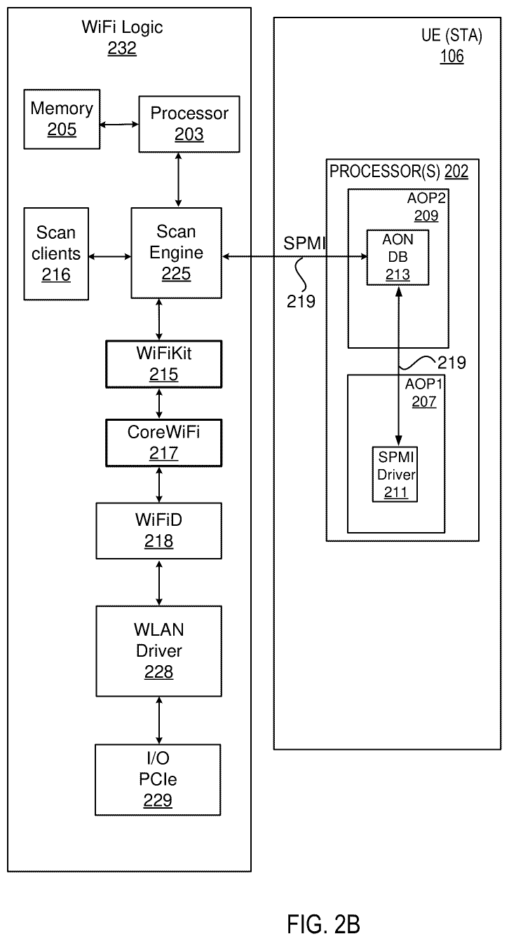

### FIGS. 2A and 2B: Block Diagram of a UE Device

FIG. 2A illustrates one possible block diagram of a UE device, such as UE device 106. In some instances (e.g., in an IEEE 802.11 communication context), the UE 106 may alternatively be referred to as a station (STA) 106, and possibly more particularly as a non-AP STA 106. As shown, the UE device 106 may include a system on chip (SOC) 200, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 200 may be coupled to various other circuits of the UE 106. For example, the UE 106 may include various types of memory (e.g., including NAND flash 210), a connector interface 220 (e.g., for coupling to a computer system, dock, charging station, etc.), the display 260, and wireless communication circuitry 230 (e.g., for LTE, LTE-A, NR, CDMA2000, Bluetooth, Wi-Fi, NFC, GPS, etc.). The connector interface 220 can also include a peripheral component interconnect express (PCIe) interface 274 that can be used for connecting high-speed components. In addition, a system power management interface (SPMI) 272 can be used as a high-speed, low-latency, bi-directional, two-wire serial bus suitable for real-time control of voltage and frequency scaled multi-core application processors and its power management of auxiliary components.

As shown, the SOC 200 may include processor(s) 202 which may execute program instructions for the UE device 106, and display circuitry 204 which may perform graphics processing and provide display signals to the display 260. The SOC 200 may also include motion sensing circuitry 270 which may detect motion of the UE 106, for example using a gyroscope, accelerometer, and/or any of various other motion sensing components. The processor(s) 202 may also be coupled to memory management unit (MMU) 240, which may be configured to receive addresses from the processor(s) 202 and translate those addresses to locations in memory (e.g., memory 206, read only memory (ROM) 250, flash memory 210). The MMU 240 may be configured to perform memory protection and page table translation or set up. In some embodiments, the MMU 240 may be included as a portion of the processor(s) 202.

The processor(s) 202 may also be coupled to one or more additional processors, such as always on processors (AOP1 207, AOP2 209) that are configured to operate continuously at the UE 106 using relatively low power. When the UE is placed in a sleep mode, the AOP1 207 and AOP2 209 continue to operate. The SPMI 272 can be used to communicate information from an SPMI driver 211 operating on AOP1 207 to an always on database (AON DB 213) on AOP2 209. Alternatively, a portion of the processor 202 (e.g. one or more cores of processor 202) may be configured to operate as an AOP of the UE 106. A daemon operating as a scan engine 225 can interface the one or more processors 202, such as the AOP1 207 and/or the AOP2 209, the Wi-Fi Logic 232 on radio 230 and/or the cellular modem 234 and/or the Bluetooth logic 236 of the radio 230 to scan for other APs, base stations, or available Bluetooth devices.

The UE device 106 may include at least one antenna, and in some embodiments, multiple antennas 235A and 235B, for performing wireless communication with access points, base stations and/or other devices. For example, the UE device 106 may use antennas 235A and 235B to perform the wireless communication. As noted above, the UE device 106 may in some embodiments be configured to communicate wirelessly using a plurality of wireless communication standards or radio access technologies (RATs).

The wireless communication circuitry 230 may include Wi-Fi Logic 232, a Cellular Modem 234, and Bluetooth Logic 236. The Wi-Fi Logic 232 is for enabling the UE device 106 to perform Wi-Fi or other WLAN communications on an IEEE 802.11 network. The Bluetooth Logic 236 is for enabling the UE device 106 to perform Bluetooth communications. The cellular modem 234 may be a cellular modem capable of performing cellular communication according to one or more cellular communication technologies such as 3GPP.

As described herein, UE 106 may include hardware and software components for implementing embodiments of this disclosure. For example, one or more components of the wireless communication circuitry 230 (e.g., Wi-Fi logic 232, cellular modem 234, BT logic 236) of the UE device 106 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

FIG. 2B illustrates an additional example block diagram of the UE (STA) 106. In this example, the scan engine 225 operating on the radio 230 is configured to communicate with the one or more of the always on processors AOP1 207 and AOP2 209 operating in the UE (STA) 106. The scan engine 225 may communicate via an interface, such as an SPMI interface 272, to an SPMI driver 211. In this example, the SPMI driver 211 is operating on AOP1 207. However, this is not intended to be limiting. The SPMI driver 211 may also operate on AOP 209. In addition, other types of interfaces, such as the PCIe 274 may be used, depending on the structure of the AOPs 207, 209 and the SOC 200.

The Wi-Fi Logic 232 operating on the radio can include a processor 203 in communication with a memory 205 and the scan engine 225. The processor 203 can be a low power processor that allows the radio 230 to operate even when the UE is in a sleep mode. The memory 205 can be a relatively small memory. For example, the memory may only store the results of a single scan from the scan engine. When a new scan is performed, the results may overwrite the results of the previous scan. The processor 203 and memory 205 may not be capable of communicating scan results to the processors 202 when the UE is in a sleep mode. The processor 203 and memory 205 may be capable of communicating with the AOP1 207 or AOP2 209 when the UE is in a sleep mode, via an interface such as the SPMI interface 272. An SPMI connection 219 may be formed between the scan engine 225 and the AON DB 213. The AON DB may also receive Wi-Fi scan information from the processor 203 or memory 205. The SPMI connection 219 may be controlled by an SPMI driver 211. An SMPI interface may also operate on the UE 106 to enable communication between separate devices in the UE, such as the radio 230, the SOC 200, and the AOP1 207 and/or AOP2 209. While the AOP1 207 and AOP2 209 are illustrated as being a part of processor 202, this is not intended to be limiting. The AOP1 207 and/or AOP2 209 can be located on a separate logic device from the processor 202. The AOP1 207 and/or AOP2 209 can also be located on a separate logic device than the SOC 200. Accordingly, even if the SOC 200 is in a sleep mode, the AOP1 207 and/or AOP2 209 can still operate and communicate with the Wi-Fi logic 232 on the radio 230.

The scan engine 225 located on the radio 230 can communicate with the AOP2 209 and/or AOP1 207, located in the UE, via an interface, such as the SPMI interface 219 or the PCIe 274 to communicate the scan results from the scan engine 225 to the AON database 213. The scan results can comprise a list of Wi-Fi APs that are within a selected range or have a power level greater than a selected threshold level. In one example, the scan results may include the basic service set identifier (BSSID) of each Wi-Fi AP within a selected range or having a power level greater than a selected threshold. The BSSID can be used to obtain the service set identifier (SSID) of each access point.

The scan results can be stored in the always on database (AON DB) 213, operating on the AOP2 209 in this example. The information can be communicated through a series of daemons, including a WiFikit 215, a CoreWiFi 217, and a WiFiD 218. A WiFiKit is a client framework for showing Wi-Fi related UI information such as scan results, associated network information, and so forth.

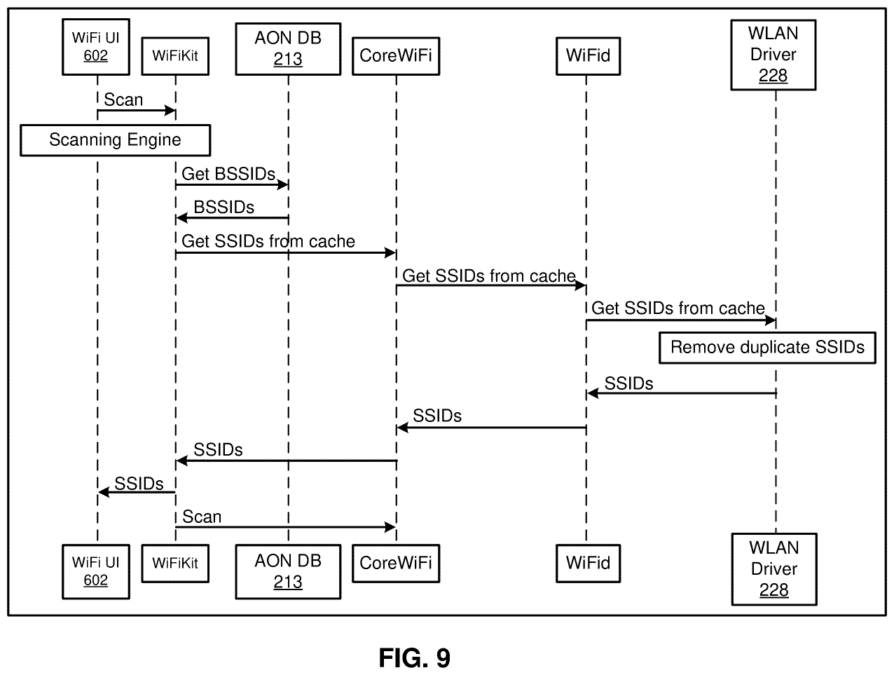

The CoreWiFi is a library that allows client software to interact with the WiFiD for various Wi-Fi use cases. A WiFiD daemon 218 is responsible for maintaining Wi-Fi associations and implementing Wi-Fi policies to scan and connect to known networks. These processes will be described more fully with respect to FIG. 9. In one example, the information in the AON database 213 can be communicated via the WiFikit 215, the CoreWiFi 217, and the WiFiD 218 to a WLAN driver 228 and through the I/O PCIe 229 to be used by the UE (STA) 106. There are also other ways of accessing the scan engine 225 and AON DB as will be further discussed herein. The block diagram illustrated in FIG. 2B is provided as one example. However, it is not intended to be limiting. Various elements and steps may be removed or performed differently.

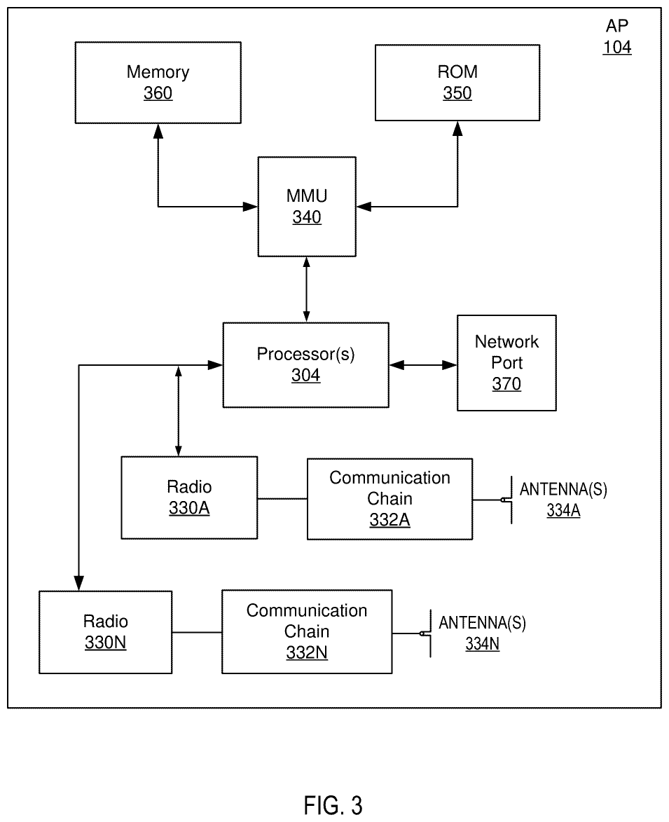

### FIG. 3: Block Diagram of an Access Point

FIG. 3 illustrates an example block diagram of an access point (AP) 104, according to some embodiments. In some instances (e.g., in an IEEE 802.11 communication context), the AP 104 may also be referred to as a station (STA), and possibly more particularly as an AP STA. It is noted that the AP of FIG. 3 is merely one example of a possible access point. As shown, AP 104 may include processor(s) 304 which may execute program instructions for the AP 104. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The AP 104 may include at least one network port 370. The network port 370 can be configured to couple to a telephone network or a data network and provide a plurality of devices, such as UE devices 106, access to the telephone network or the data network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

The AP 104 may include one or more radios 330A-330N, each of which may be coupled to a respective communication chain and at least one antenna 334, and possibly multiple antennas. The antenna(s) 334 may be configured to operate as a wireless transceiver and may be further configured to communicate with UE devices 106 via radio 330. The antenna(s) 334A-N communicate with their respective radios 330A-N via communication chains 332A-N. Communication chains 332 may be receive chains, transmit chains, or both. The radios 330A-N may be configured to communicate via various wireless communication standards, including, but not limited to, 3GPP LTE, 3GPP LTE-A, 3GPP NR, GSM, UMTS, CDMA2000, IEEE 802.11 Wi-Fi, etc. The AP 104 may be configured to operate in multiple wireless links using the one or more radios 330A-N, wherein each radio is used to operate in a respective wireless link.

The AP 104 may be configured to communicate wirelessly using multiple wireless communication standards. In some instances, the AP 104 may include multiple radios, which may enable the network entity to communicate according to multiple wireless communication technologies. For example, as one possibility, the AP 104 may include an LTE or 5G NR radio for performing communication according to LTE as well as a Wi-Fi radio for performing communication according to Wi-Fi. In such a case, the AP 104 may be capable of operating as both an LTE base station and a Wi-Fi access point. As another possibility, the AP 104 may include a multi-mode radio which is capable of performing communications according to any of multiple wireless communication technologies (e.g., NR and Wi-Fi, NR and UMTS, LTE and CDMA2000, UMTS and GSM, etc.). As still another possibility, the AP 104 may be configured to act exclusively as an IEEE 802.11 Wi-Fi access point, e.g., without cellular communication capability.

As described further subsequently herein, the AP 104 may include hardware and software components for implementing or supporting implementation of features described herein. The processor 304 of the access point 104 may be configured to implement or support implementation of part or all of the methods described herein, e.g., by executing program instructions stored on a memory medium (e.g., a non-transitory computer-readable memory medium) to operate multiple wireless links using multiple respective radios. Alternatively, the processor 304 may be configured as a programmable hardware element, such as an FPGA (Field Programmable Gate Array), or as an ASIC (Application Specific Integrated Circuit), or a combination thereof. Alternatively (or in addition) the processor 304 of the AP 104, in conjunction with one or more of the other components 330, 332, 334, 340, 350, 360, 370 may be configured to implement or support implementation of part or all of the features described herein.

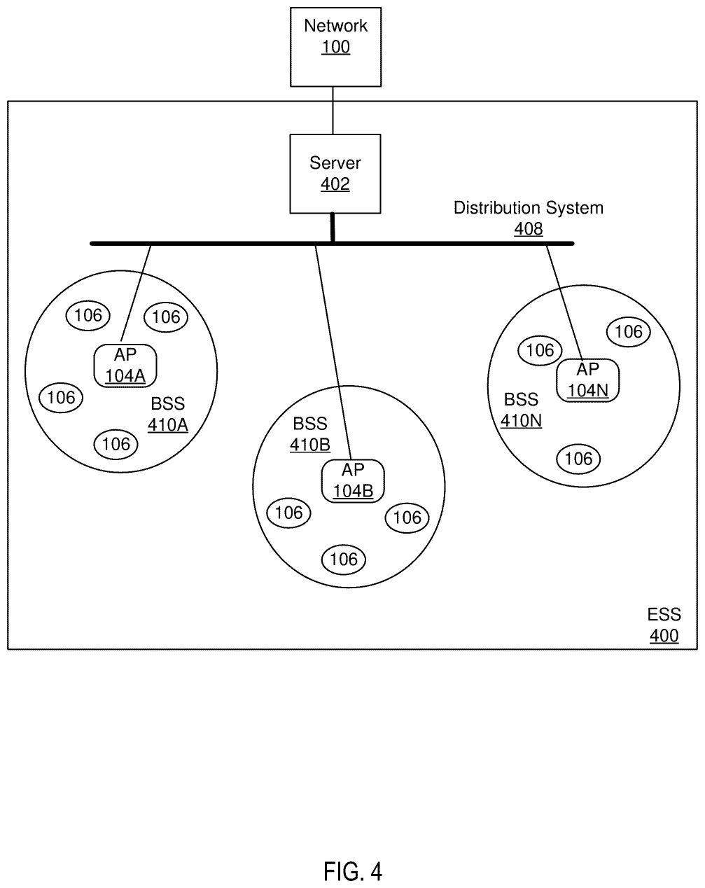

### FIG. 4: Block Diagram of an IEEE 802.11 Wi-Fi Configuration

FIG. 4 illustrates an example block diagram of an IEEE 802.11 configuration, according to some embodiments. It is noted that the block diagram of the configuration illustrated in FIG. 4 is only one example of a possible configuration. According to some embodiments, a server 402 can be communicatively coupled to a network 100, such as the internet or a local network, and a distribution system 408. The distribution system 408 can be used to couple a plurality of access points 104A, 104B . . . 104N to the server 402. The server 402 can also be a gateway. In one embodiment, one or more of the APs 104A . . . N may be wirelessly connected to other APs, with one or more of the plurality of APs 104A . . . N APs wired to the server. Each AP can wirelessly connect to one or more UEs 106, also referred to as mobile stations or STA, based on the IEEE 802.11 standard, and provide a wireless connection for the one or more UEs 106 to the network 100. An AP, such as 104A, and the one or more UEs 106 form a basic service set BSS 410A. Multiple BSS, such as 410A, 410B . . . 410N form an extended service set (ESS) 400. The ESS 400 can be interlinked through wired or wireless backbones that form the distribution system 408. The ESS 400, distribution system 408, and server 402 can comprise a single MAC layer network.

In an environment with multiple APs, such as a mall, an office building, or a campus, a UE can move from the range of one AP to another and still maintain a continuous wireless connection. This is possible due to the underlying architecture of the IEEE 802.11 standard which allows for roaming by the UEs 106 between APs 104A . . . N.

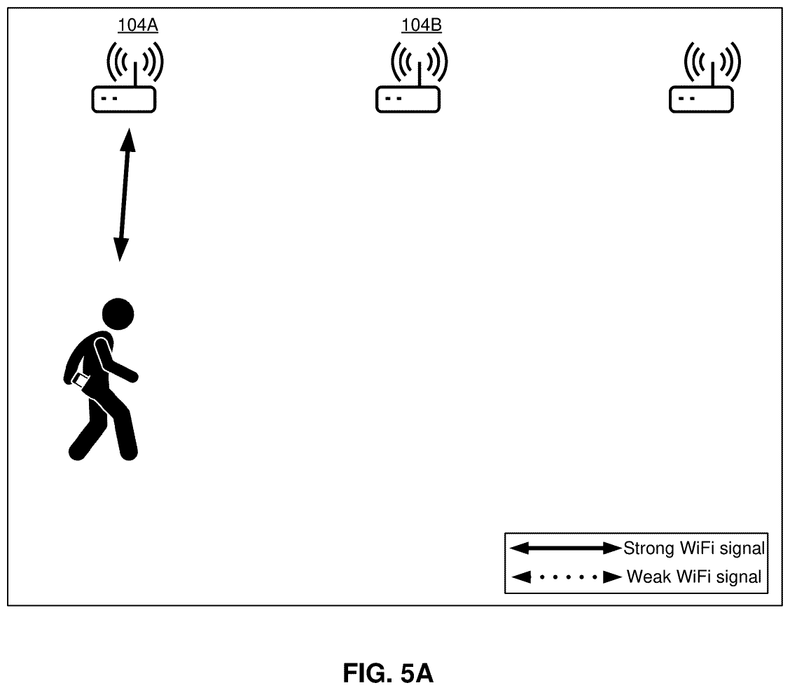

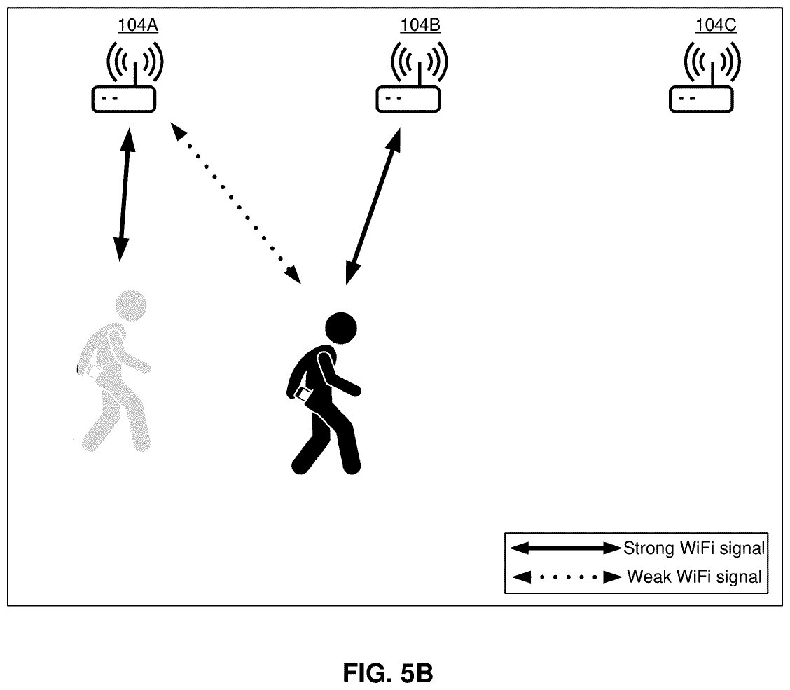

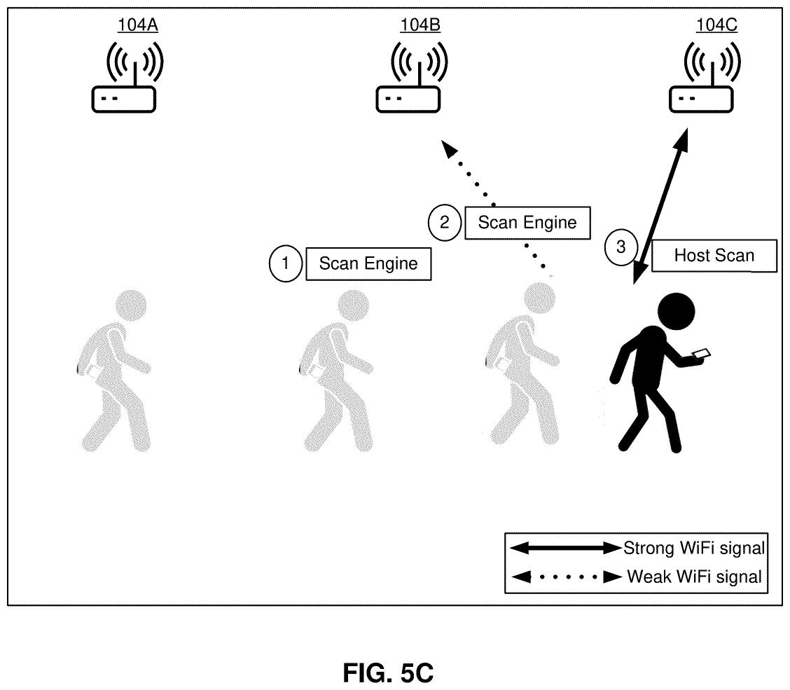

### FIGS. 5A-5C: Block Diagram of IEEE 802.11 Roaming and Handover

Modern UEs, such as phones, tablets, laptops, and other mobile computing devices are designed to minimize power usage in order to maximize battery life.

In order to conserve battery life, a UE, such as phones, tablets, laptops, and other mobile computing devices, may enter into a reduced power mode when not connected to a constant power supply and not actively being used (e.g., an idle state). This is typically referred to as “sleep” mode. Computer processors (e.g. central processing units and other types of processors) typically have high power consumption when they are operating. Accordingly, when processors are not needed, they are usually shut off and/or put into a low power mode, often referred to as a sleep mode, in which the processors are designed to consume very little power in order to reduce overall power consumption.

The sleep mode of particular UE (STA) devices may be different depending on the characteristics of the UE device. For example, in the case where the UE device has network access, (e.g., cellular access, Wi-Fi access, etc.), a sleep mode may include temporally putting the main processor 202 of the UE 106 to sleep and turning off the display 260 and display circuitry 204, yet keeping the network stack, such as the radio 230 in an operable function. Thus, while operating in sleep mode, an exemplary UE device 106 may continue to receive information from the internet and cellular data including phone calls and/or items of interest from notification services (e.g., email messages from a push email service and/or from a pull email service) from one or more of a Wi-Fi network, a cellular network, or a Bluetooth connection. When information is received, the UE 106 may be awakened to process those phone calls and/or notifications. For example, a UE awakes after receiving a phone call while in sleep mode so a user may answer the phone call. Additionally, UEs typically cannot refresh the data context while the UE is operating in sleep mode (thus, a mobile device typically needs to be awake to refresh a data context). Thus, a connection with a wireless network or the internet is actively maintained even when the UE 106 itself is in a sleep mode, such as when the UE hasn't been activated or used for a certain amount of time, and/or when the UE's display screen has been turned off.

FIG. 5A provides an example illustration of a mobile user with a UE operating in sleep mode while the user moves between APs in accordance with some embodiments. The UE is typically in a sleep mode while located in a user's pocket, with the screen and processor operating in a low power mode, with one or more processor(s) 202 turned off or operating in a low power mode, as illustrated in FIG. 5A. However, a digital processor that is configured to maintain a wireless connection for the UE, such as one or more processors 202 illustrated in FIG. 2A or processors on radio 230 that are configured to operate one or more of the Wi-Fi logic 232, the cellular modem 234, and/or the Bluetooth logic 236 on the radio 230, is configured to operate even when the UE 106 is in a standby mode or a sleep mode with its screen turned off.

In one embodiment, as illustrated in FIG. 2B, the Wi-Fi Logic 232, the cellular modem 234, and the Bluetooth logic may each have separate processors. Alternatively, in the example of FIG. 5A, the processor 202 on the SOC 200 on the UE 106 may be configured to operate the Wi-Fi logic 232 and maintain a strong Wi-Fi connection with the wireless AP 104A when the user is near to the AP 104A. As the user walks along, the user will move away from AP 104A and move towards AP 104B, as shown in FIG. 5B. When this happens, the signal strength of the Wi-Fi signal from the AP 104A will begin to weaken, and the signal strength of the Wi-Fi signal from AP 104B will increase. The Wi-Fi logic 232 can communicate with the scan engine 225 that is configured to scan for Wi-Fi signals from APs 104A . . . N that are within a range of the UE 106.

In one example, the scan engine 225 operating at the UE (STA) 106 can identify each AP that is located adjacent to the UE 106. An AP is considered to be adjacent to the UE when the AP transmits a Wi-Fi signal with a received signal strength indicator (RSSI) power level, as measured at the UE, which is greater than a predetermined threshold power level. For example, any Wi-Fi signal that is received from an adjacent AP at a UE 106 with an RSSI that is greater than −80 decibel-milliwatts (dBm) may be saved by the scan engine. This value is not intended to be limiting. Depending on the type of UE, a Wi-Fi signal received at the UE from an AP with an RSSI (as measured at the UE) with a power level that is greater than −80 dBm to −110 dBm may be saved. The actual minimum threshold power can depend on the system parameters. Additional information regarding each access point 104 can also be obtained by the scan engine 225. For example, the scan engine may receive information from each access point including the AP's BSSID, SSID, supported communication rates, beacon interval, and so forth. In addition, the scan engine 225, or other components such as the WLAN driver 228 can have predetermined information regarding APs within the vicinity of the UE. This predetermined information may be associated with the measurements of the scan. The Wi-Fi logic 232 may be configured to connect the UE 106 to the AP having the highest RSSI.

In one example, the minimum use threshold level for the Wi-Fi logic 232 to switch to another AP can be −70 dBm. If an AP that is currently used to connect the UE 106 to an AP falls below a power of −70 dBm, the Wi-Fi logic 232 can be configured to switch to another AP. This level is not intended to be limiting. Depending on the type of UE 106 and the environment in which the UE 106 and APs 104A . . . N are operating, the threshold value for performing a handover may be between −50 dBm and −80 dBm. Performing the handover will be discussed more fully in the proceeding paragraphs.

When a Wi-Fi signal from an AP that is actively being used by the UE has an RSSI that drops below a certain use threshold level, the Wi-Fi logic 232 can perform a handover and/or seamless switching of the UE to use a different AP that has a Wi-Fi signal received at the UE with a greater RSSI than the signal received from current AP. Handover and seamless switching are two techniques that enable the UE to switch from one AP or network to another without losing connection or data. Handover is the process of transferring a device's association from one AP to another within the same network, while seamless switching is the process of moving a device from one network to another without noticeable interruption or re-authentication. Both techniques are used to provide continuous and smooth wireless service to a user of the UE.

Handover can enable a user to walk around a building or campus that has a Wi-Fi network and maintain a stable connection to the same network, while seamless switching can enable a user to switch from the Wi-Fi network to a cellular network or vice versa without noticing any delay or disruption.

Depending on the type and level of handover or switching, protocols and mechanisms can be employed that involve different layers of the network stack, such as the physical layer, link layer, network layer, or application layer. For example, some common handover and switching techniques are referred to as a layer 2 handover, which is the most basic type of handover where a UE device switches from one AP to another within the same network based on signal strength and quality. A layer 3 handover is a more advanced type of handover where a device switches from one AP to another across different subnets or networks based on network layer information. A vertical handover is a type of seamless switching where a UE device switches from one network to another with different radio access technologies, such as Wi-Fi and 3GPP. Application layer seamless switching is a type of seamless switching where a UE device switches from one network to another with the same or different technologies based on application layer information. Each of these techniques uses various levels of cooperation and coordination between different layers of the network stack to provide a good user experience and satisfaction. In one embodiment, the Wi-Fi logic 232 can be configured to perform each of these types of handovers while the UE 106 is in a sleep mode.

Returning to FIG. 5B, the scan engine 225 can periodically measure the RSSI of all of the received signals from APs that are located adjacent to the UE. As the user walks a distance away from the AP 104A, the signal will eventually drop below a threshold RSSI power level, such as −70 dBm. At this point, the Wi-Fi logic 232 is configured to perform a seamless handover to the Wi-Fi AP that has the highest RSSI, as received in the previous scan. In the example of FIG. 5B, the AP 104B is closest. If the AP 104B has the Wi-Fi signal with the highest received RSSI at the UE 106, then the AP 104B will be selected and the handover will be performed. As previously noted, many of the processor(s) 202 in the UE 106 may be turned off or operating in a low power mode during the Wi-Fi handover procedure when the UE is in a sleep mode. However, one or more AOP will be operating to ensure that the handover is performed, even when the UE is not active.

In some embodiments, while the UE 106 is operating in a sleep mode, which can also be referred to as a low power mode, the Wi-Fi logic 232, operating on a Wi-Fi chip or a radio interface 230 that is separate from the SOC 200, is configured to store the information obtained from a scan of the adjacent Wi-Fi access points for use in maintaining the Wi-Fi connection for the UE. In other words, while a UE is roaming between APs, the scan engine 225 can enable the UE to roam between multiple APs when the host processor 202 is asleep and perform a seamless transition to another AP. The information stored in the Wi-Fi logic 232 is not communicated to the SOC 200 since elements on the SOC 200 are substantially operating in a sleep mode.

FIG. 5C illustrates an example in which the user continues to travel past AP 104B and towards AP 104C with the UE operating in a sleep mode (low power mode). The scan engine 225 will periodically scan and measure the RSSI power levels of the Wi-Fi signals from the adjacent APs that have signals above the minimum threshold power level (e.g. greater than a threshold value of −90 dB to −70 dB). When the Wi-Fi signal from the AP 104B that the UE 106 is connected to is below a threshold power level, the Wi-Fi logic 232 will select the Wi-Fi AP with the highest signal power, which in this example is the AP 104C. A handover will be performed, and the UE 106 will connect to AP 104C.

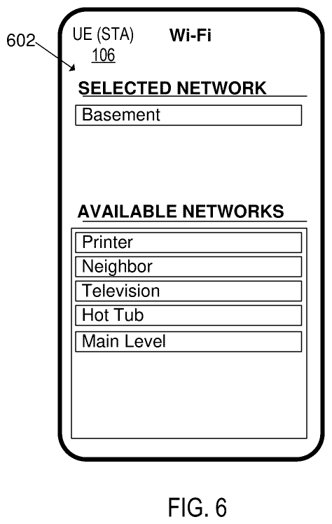

### FIG. 6: Example User Interface of a UE

In the example of FIG. 5C, the user may activate the UE 106 by moving it, taking it out of their pocket, or otherwise turning it on to change the UE from a sleep mode to an active mode. The user may then use the UE's user interface to select which Wi-Fi network the UE is connected to (e.g. which Wi-Fi AP for the UE to form a data link with). For example, FIG. 6 illustrates an example user interface (UI) 602 of a UE 106. In this example, the UE may display a service set identifier (SSID) for a “Selected” Wi-Fi network that that the UE is currently connected to (e.g. “Basement”, and the SSIDs of the “Available Networks” that the UE can connect with. Additional information may also be displayed in the UI 602, including but not limited to a power level indicator showing a relative strength of the Wi-Fi Signal, the frequency band of the Wi-Fi signal, and whether the Wi-Fi signal is encrypted.

When the user selects the UI 602 to identify which Wi-Fi networks (SSIDs) are available at the UE's location, the UE 106 may send a request to the Wi-Fi logic 232 on the radio 230. Since the Wi-Fi logic 232 does not typically communicate with the processor(s) 202 while the processor(s) 202 are in a sleep mode or otherwise turned off, a new Wi-Fi scan is initiated by the UE. The Wi-Fi logic will perform a new scan. The process for the UE 106 to request the Wi-Fi logic 232 to perform a new Wi-Fi scan, measure all of the Wi-Fi signals of the adjacent APs that have an RSSI that is greater than a minimum connection threshold and communicate the information to a user interface (UI) to display, can take several seconds. With the advent of additional bands that can be used by Wi-Fi, such as the 6 gigahertz (GHz) band used by Wi-Fi 6e and Wi-Fi 7, the time to scan each of the potential bands that each adjacent AP may operate in can take even longer. Accordingly, the user typically may wait for several seconds (e.g. 2 to 6 seconds) for the UE 106 to populate the UI 602 with the available network information, such as the SSIDs. The user can then select a different network, if desired.

Referring to FIG. 2A, the radio 230 that includes the Wi-Fi logic 232 does not typically communicate with the SOC 200 while the UE 106 is operating in a sleep mode. As previously discussed, the processor 202, or most of the cores of the processor(s) 202, are typically turned off or operating in a low power mode when the UE is operating in a sleep mode, and the Wi-Fi radio 230 does not communicate information to the SOC 200 that is obtained during scans of the adjacent APs. This is one reason why it takes the UE several seconds to perform a scan and display the information in the UI 602 that is illustrated in FIG. 6.

In accordance with some embodiments, the UE 106 can include one or more AOPs, such as AOP1 207 and AOP2 209 illustrated in FIGS. 2 and 2B. The Wi-Fi logic 232 can include an interface, such as an SPMI 272 or PCIe 274, or another interface that enables the radio 230 to communicate with the one or more AOPs 207, 209 while the UE is operating in a sleep mode. This enables the information that is obtained by the scan engine 225 on the radio 230 and the Wi-Fi logic 232 in a Wi-Fi scan, while the UE is in a sleep mode, to be communicated to an always on database (AON DB) 213 that is operating on an AOP, such as AOP2 209 of the UE 106. An SPMI interface 272 may be used to enable communication between the AOPs, such as AOP1 207 and AOP2 209. The UI can display SSID information for APs that can have any type of handover, including Layer 2 handover, Layer 3 handover, and vertical handovers, as previously discussed.

The Wi-Fi scan information in the AON DB 213 can be communicated to the UI 602 and be available for display in the UI 602 almost immediately, in a time period of a few milliseconds or less. This will be discussed more fully in the proceeding paragraphs.

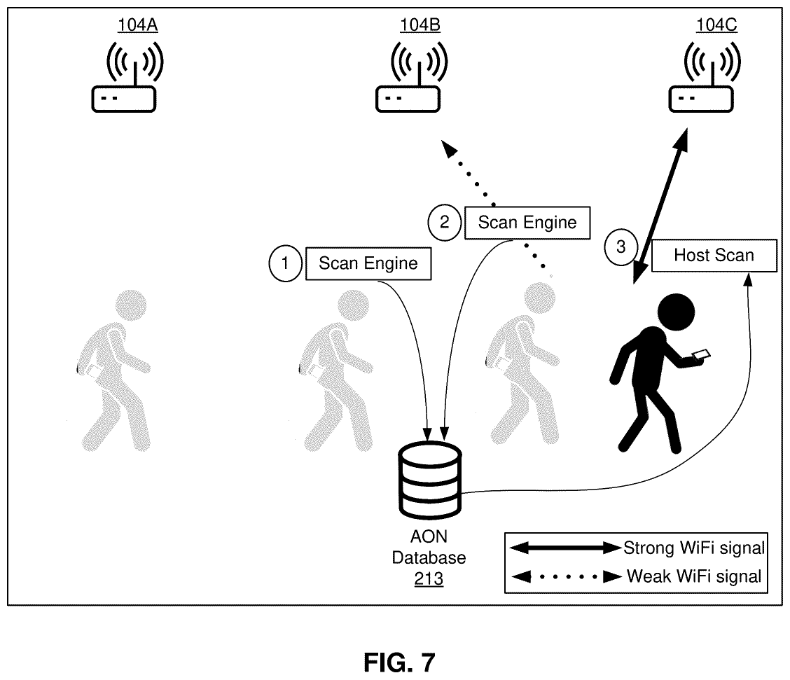

FIG. 7: Example Diagram of a User Activating the UE from a Sleep Mode

FIG. 7 illustrates an example in which the user activates the UE 106. In this example, the user removes the UE from their pocket and selects a Wi-Fi UI 602 to select an AP for the UE to connect to. The UE is currently connected to the AP 104C. However, the user may want to connect the UE to a different AP, such as a specific AP that connects to specific equipment, an AP that operates in a higher frequency band for more bandwidth, an AP that operates in a single band in order to connect with wireless devices that only communicate in that band, or any other AP desired by the user. In this example, when the user activates the Wi-Fi UI 602, the UI 602 on the UE 106 is able to obtain the information that is obtained by the radio 230 and the Wi-Fi logic 232 in the Wi-Fi scan from the AON database 213. The amount of time needed for the UE 106 to obtain this information and display it in the UE 602 is typically in the microseconds or milliseconds, rather than the several seconds that it takes for the UE 106 to perform another Wi-Fi scan of available Wi-Fi APs. Accordingly, when the user activates the Wi-Fi UI 602, the SSIDs of the scanned APs that are selected for display in the UI 602 are nearly instantly displayed, thereby allowing the user to select which AP to connect to without any appreciable delay to wait for an additional scan to be performed.

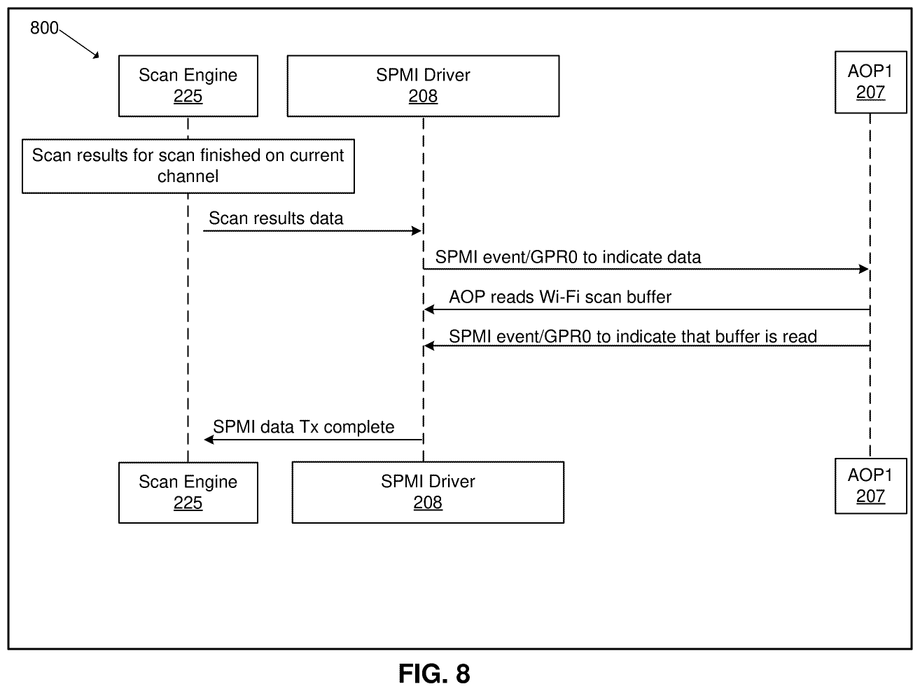

### FIGS. 8 and 9: Example Flow Charts

FIG. 8 illustrates an example flow chart 800 in which data from the scan engine 225 is communicated to an always on processor AOP1 207. In this example, the scan results for a Wi-Fi scan performed by the radio 230 are communicated to the SPMI driver 208. A general purpose radio 0 (GPR0) register in the SPMI driver 208 can indicate an SPMI event to the AOP1 207. The AOP1 207 may then read a Wi-Fi scan buffer in the SPMI driver 208. The AOP1 207 may send an SPMI event to the GPR0 register in the SPMI driver to indicate that the Wi-Fi scan buffer was read. The SPMI driver 208 may then send an indicator to the scan engine 225 that the SPMI data transmission is complete. The details in the example of FIG. 8 are not intended to be limiting. Rather, they merely show one potential embodiment for communicating the Wi-Fi scan results data from the radio 230 to the AOP1 when the UE 106 is operating in a sleep mode. As previously discussed, the SOC 200 may be in a sleep mode at the time the scan results data is communicated to the AOP1 227.

FIG. 9 provides an example diagram illustrating a flow chart for the Wi-Fi UI 602 to receive the Wi-Fi scan results upon wakeup of the UE, or when the user activates the UI. In this example, upon wakeup or activation of the Wi-Fi UI 602, the Wi-Fi UI can send a scan request to a WiFiKit. The WiFiKit is a client framework for showing Wi-Fi related UI information such as scan results, associated network information, and so forth. The WiFiKit can send a GET command to the AON DB 213 to receive the BSSIDs from the AON DB 213. The AON DB 213 can send the BSSIDs from the Wi-Fi scan results to the WiFiKit. The WiFiKit can then send a GET request to obtain the SSIDs for the BSSIDs from a memory cache in the WLAN driver 228. In one example, the GET request for the SSIDs can be sent from the WiFiKit to a CoreWiFi. The CoreWiFi is a library that allows client software to interact with the WiFid for various Wi-Fi use cases. The CoreWiFi can send the Get SSIDs to the Wifid. The Wifid is the daemon responsible for maintaining Wi-Fi associations and implements Wi-Fi policies to scan and connect to known networks. The Wifid can then forward the Get request for the SSIDs to the WLAN driver 228. The WLAN driver 228 can obtain the SSIDs for the BSSIDs and remove duplicate SSIDs. The WLAN driver 228 can then send the SSIDs to the WiFiKit, via the Wifid and CoreWiFi. The Wi-Fi UI 602 can then display the SSIDs that are associated with the BSSIDs from the scanning engine 225 that were obtained in a Wi-Fi scan.

In one embodiment, the AON DB 213 can also include timestamp information to enable the UE to identify how old the BSSID information is in the AON DB 213. If the data is older than a certain threshold, then a new scan may be performed, and the Wi-Fi UI 602 updated with the SSIDs from the new scan. The threshold may be dependent on a speed of the UE. If the UE has a higher speed (e.g. higher doppler), then the new scan will need to be performed more often, such as every few seconds or more frequently. If the UE has a low speed or is stationary, then the previous scan may be sufficient for several minutes.

In some embodiments, an apparatus of a user equipment (UE) is disclosed that comprises: one or more processors, coupled to a memory configured to: perform an update of a Wi-Fi user interface (UI) of the UE comprising: request a basic service set identifier (BSSID) from an always on database (AON DB) operating on an always on processor of the UE for one or more APs operating adjacent to the UE; receive one or more service set identifiers (SSIDs) for the BSSID from the memory of the UE; and display the one or more SSIDs in the Wi-Fi UI to enable a user to select an SSID of an AP for the UE to form a Wi-Fi data link with. The one or more processors can be a processor in the radio 230 configured to function with the Wi-Fi logic 232.

In some embodiments, the AON DB further comprises timestamp information for each basic service set identifier (BSSID) that is stored in the AON DB to enable a time period since a Wi-Fi scan was performed to be determined. The time period can be the time from the Wi-Fi scan to the time that the AON DB is queried regarding the scan. The time can be used to determine whether the data regarding the RSSI of adjacent APs is still valid. If the UE has moved appreciably since the last scan was performed, then a new scan may need to be performed.

In some embodiments, an additional scan can be performed by a Wi-Fi radio of the UE to obtain updated scan results of APs when a time period is greater than a predetermined threshold. The threshold time period can depend on the speed of the UE, as previously discussed.

In some embodiments, an apparatus of a UE is disclosed that comprises one or more processors, coupled to a memory configured to: perform a scan by a Wi-Fi radio of the UE to obtain scan results of APs operating adjacent to the UE while the UE operates in a sleep mode with one or more processors of the UE operating in the sleep mode; send one or more of the scan results of the APs from the Wi-Fi radio to an always on processor (AOP) of the UE; store the scan results in an always on database (AON DB). The AON DB may be on the AOP or on a different AOP. The AON DB can be accessed by the one or more processors of the UE when the UE is not operating in the sleep mode to enable the UE to display information for the one or more of the scan results stored in the AON DB.

In some embodiments, the information for the one or more of the scan results is displayed in a user interface (UI) of the UE without performing an additional scan by the Wi-Fi radio when the UE is not operating in the sleep mode.

In some embodiments, the information for the one or more of the scan results in the UI is displayed on a video display of the UE. The information for the one or more of the scan results can be displayed in the UI of the UE to enable a user of the UE to select an AP detected by the scan for the Wi-Fi radio of the UE to connect with. In some embodiments, the information for the one or more of the scan results can be displayed in a user interface (UI) of the UE within a time period of less than 10 milliseconds (ms) after a user activates the UI. This time period is not intended to be limiting. Rather, it is used to show that the UI can be populated with the information from the scan results much more quickly by accessing the data from the AON DB rather than performing a new Wi-Fi scan.

In some embodiments, the one or more processors and memory are configured to store data link information for APs that have a received signal strength indicator (RSSI) measured at the UE with a power level that is greater than a selected threshold level. The memory may be a memory on the Wi-Fi logic 232, such as memory 205. However, as previously discussed, this memory may only be capable of storing a single scan. When a new scan is performed, perhaps 2 to 3 seconds later, then the results will be replaced with the scan information from the new scan. In order to preserve the scan data, the scan data can be communicated to the AON DB 213 via the SPMI interface. The AON DB may be capable of storing tens or hundreds of scan results. Alternatively, the AON DB may only store a limited number of scan results. However, the AON DB can communicate with the UI 602 when the UE is awakened from a sleep mode. In contrast, the UI 602 may not be configured to obtain scan information from the Wi-Fi logic 232 without performing a new scan when the UE is awakened from the sleep mode.

In some embodiments, the data link information comprises a power level of the RSSI, a basic service set identifier (BSSID), security information, and signal band of the APs that have the RSSI with the power level that is greater than the selected threshold level. The one or more processors are further configured to send the one or more of the scan results of the APs from the Wi-Fi radio 230 to the AOP (AOP1 207 and/or AOP2 209) of the UE 106 via a system power management interface (SPMI) connection between the Wi-Fi radio and the AOP.

In some embodiments, the one or more processors are further configured to: perform an update of a Wi-Fi UI of the UE comprising: send a request, from the UI, for a basic service set identifier (BSSID) from the AON DB for the one or more APs of the APs operating adjacent to the UE; receive one or more service set identifiers (SSIDs) for the BSSID from a memory cache of the UE; and display the one or more SSIDs in the Wi-Fi UI to enable a user to select an SSID of an AP for the UE to form a Wi-Fi data link with.

In some embodiments, a Wi-Fi radio processor, such as processor 203, is configured to cause the UE to perform one or more of the methods of claims 1 to 11. Additional processors 202 operating on the SOC 200 of the UE 106 are also configured to cause the UE to perform one or more of the methods of claims 1 to 11. AOP1 207 and/or AOP2 209 processors are also configured to cause the UE to perform one or more of the methods of claims 1 to 11. Each of the processors 202, 203, 207, and 209 can be in communication with one or more memory, as previously discussed and illustrated. In addition, a computer program product, comprising computer instructions which, when executed by one or more processors, can perform any of the operations described herein.

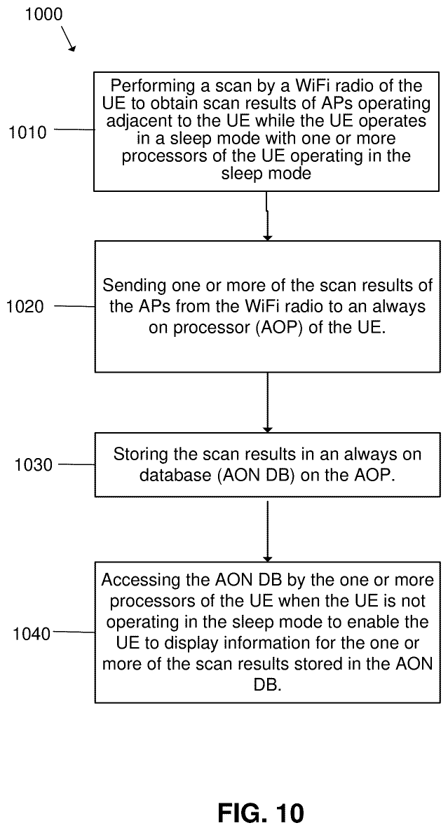

### FIG. 10: Method of Enabling AI/ML Based Positioning-Common Reference Time

FIG. 10 illustrates an example flow chart of a method 1000 of providing Wi-Fi access point (AP) information in a user equipment (UE), according to some embodiments.

The method shown in FIG. 10 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 1000, of providing Wi-Fi access point (AP) information in a user equipment (UE), comprises performing a scan by a Wi-Fi radio of the UE to obtain scan results of APs operating adjacent to the UE while the UE operates in a sleep mode with one or more processors of the UE operating in the sleep mode, as in block 1010.

The method 1000 further comprises sending one or more of the scan results of the APs from the Wi-Fi radio to an always on processor (AOP) of the UE, as shown in block 1020. The scan results can be stored in an always on database (AON DB) of the AOP, as shown in block 1030. The method 1000 further comprises accessing the AON DB by the one or more processors of the UE when the UE is not operating in the sleep mode to enable the UE to display information for the one or more of the scan results stored in the AON DB, as shown in block 1040.

The method 1000 can further comprise displaying the information for the one or more of the scan results in a user interface (UI) of the UE without performing an additional scan by the Wi-Fi radio when the UE is not operating in the sleep mode. The information for the one or more of the scan results can be displayed on a video display of the UE. The information for the one or more of the scan results can be displayed in the user interface (UI) of the UE to enable a user of the UE to select an AP detected by the scan for the Wi-Fi radio of the UE to connect with. In one embodiment, the information for the one or more of the scan results in a user interface (UI) of the UE can be displayed in the UI of the UE within a time period of less than 10 milliseconds (ms) after a user activates the UI or the UI is displayed. This time period is not intended to be limiting. In another example, the scan results may be displayed UI within any time period between 1 microsecond and 50 milliseconds.

In one example performing the scan by the Wi-Fi radio of the UE in the method of claim 1000 to obtain scan results of APs operating adjacent to the UE comprises storing data link information for APs that have a received signal strength indicator (RSSI) measured at the UE with a power level that is greater than a selected threshold level. As previously discussed, the selected threshold may be set for a power level between −50 dBm and −90 dbm.

Storing the data link information for the APs in the AON DB further comprises, storing, for one or more APs of the APs operating adjacent to the UE with the RSSI measured at the UE with the power level that is greater than the selected threshold, a power level of the RSSI, a basic service set identifier (BSSID), security information, and a signal band in the AON DB. Additional information may also be stored in the AON DB.

The method 1000 can further comprise sending the one or more of the scan results of the APs from the Wi-Fi radio to the AOP of the UE via a system power management interface (SPMI) connection between the Wi-Fi radio and the AOP. The method 1000 can further comprise, or may alternatively comprise, storing the scan results in the AON DB that is configured on the AOP or on a separate AOP, and the AOP and the separate AOP are configured to communicate via an SPMI connection.

The method 1000 can further comprise performing an update of a Wi-Fi user interface (UI) of the UE comprising: requesting, at the UI, a basic service set identifier (BSSID) from the AON DB for the one or more APs of the APs operating adjacent to the UE; receiving one or more service set identifiers (SSIDs) for the BSSID from a memory cache of the UE; and displaying the one or more SSIDs in the Wi-Fi UI to enable a user to select an SSID of an AP for the UE to form a Wi-Fi data link with.

The AON DB can further comprise timestamp information for each basic service set identifier (BSSID) that is stored in the AON DB to enable an age of a scan to be determined. In some embodiments, an additional scan can be performed by the Wi-Fi radio of the UE to obtain updated scan results of APs when a time period is greater than a predetermined threshold.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of providing Wi-Fi access point (AP) information in a user equipment (UE), comprising:
performing a scan by a Wi-Fi radio of the UE to obtain scan results of APs operating adjacent to the UE while the UE operates in a sleep mode with one or more processors of the UE operating in the sleep mode;
sending one or more of the scan results of the APs from the Wi-Fi radio to an always on processor (AOP) of the UE;
storing the scan results in an always on database (AON DB); and
accessing the AON DB by the one or more processors of the UE when the UE is not operating in the sleep mode to enable the UE to display information for the one or more of the scan results stored in the AON DB.

2. The method of claim 1, further comprising displaying the information for the one or more of the scan results in a user interface (UI) of the UE without performing an additional scan by the Wi-Fi radio when the UE is not operating in the sleep mode.

3. The method of claim 2, further comprising displaying, on a video display of the UE, the information for the one or more of the scan results in the UI.

4. The method of claim 2, further comprising displaying the information for the one or more of the scan results in the user interface (UI) of the UE to enable a user of the UE to select an AP detected by the scan for the Wi-Fi radio of the UE to connect with.

5. The method of claim 2, further comprising displaying the information for the one or more of the scan results in a user interface (UI) of the UE within a time period of less than 10 milliseconds (ms) after a user activates the UI.

6. The method of claim 1, wherein performing the scan by the Wi-Fi radio of the UE to obtain scan results of APs operating adjacent to the UE comprises:
storing data link information for APs that have a received signal strength indicator (RSSI) measured at the UE with a power level that is greater than a selected threshold level;
wherein storing the data link information for the APs further comprises:
storing, for one or more APs of the APs operating adjacent to the UE with the RSSI measured at the UE with the power level that is greater than the selected threshold, a power level of the RSSI, a basic service set identifier (BSSID), security information, and signal band of a channel for the one or more APs.

7. The method of claim 1, further comprising:
sending the one or more of the scan results of the APs from the Wi-Fi radio to the AOP of the UE via a system power management interface (SPMI) connection between the Wi-Fi radio and the AOP; or
storing the scan results in the AON DB that is configured on the AOP or on a separate AOP, and the AOP and the separate AOP are configured to communicate via an SPMI connection.

8. The method of claim 7, further comprising:
performing an update of a Wi-Fi user interface (UI) of the UE comprising:
requesting, at the UI, a basic service set identifier (BSSID) from the AON DB of the AOP for the one or more APs of the APs operating adjacent to the UE;
receiving one or more service set identifiers (SSIDs) for the BSSID from a memory cache of the UE; and
displaying the one or more SSIDs in the Wi-Fi UI to enable a user to select an SSID of an AP for the UE to form a Wi-Fi data link with.

9. The method of claim 1, wherein the AON DB further comprises timestamp information for each basic service set identifier (BSSID) that is stored in the AON DB to enable an age of a scan to be determined.

10. The method of claim 9, further comprising:
performing an additional scan by the Wi-Fi radio of the UE to obtain updated scan results of APs when a time period is greater than a predetermined threshold.

11. An apparatus of a user equipment (UE) comprising:
one or more processors, coupled to a memory configured to:
perform an update of a Wi-Fi user interface (UI) of the UE comprising:
request a basic service set identifier (BSSID) from an always on database (AON DB) operating on an always on processor of the UE for one or more APs operating adjacent to the UE;
receive one or more service set identifiers (SSIDs) for the BSSID from the memory of the UE; and
display the one or more SSIDs in the Wi-Fi UI to enable a user to select an SSID of an AP for the UE to form a Wi-Fi data link with.

12. The apparatus of claim 11, wherein the AON DB further comprises timestamp information for each basic service set identifier (BSSID) that is stored in the AON DB to enable an age of a scan to be determined.

13. The apparatus of claim 11, further comprising performing an additional scan by a Wi-Fi radio of the UE to obtain updated scan results of APs when a time period is greater than a predetermined threshold.

14. An apparatus of a user equipment (UE) comprising:
one or more processors, coupled to a memory configured to:
perform a scan by a Wi-Fi radio of the UE to obtain scan results of APs operating adjacent to the UE while the UE operates in a sleep mode with one or more processors of the UE operating in the sleep mode;
send one or more of the scan results of the APs from the Wi-Fi radio to an always on processor (AOP) of the UE;
store the scan results in an always on database (AON DB) on the AOP; and
access the AON DB by the one or more processors of the UE when the UE is not operating in the sleep mode to enable the UE to display information for the one or more of the scan results stored in the AON DB.

15. The apparatus of claim 14, wherein the information for the one or more of the scan results is displayed in a user interface (UI) of the UE:
without performing an additional scan by the Wi-Fi radio when the UE is not operating in the sleep mode; or
on a video display of the UE; or
to enable a user of the UE to select an AP detected by the scan for the Wi-Fi radio of the UE to connect with.

16. The apparatus of claim 14, wherein the information for the one or more of the scan results is displayed in a user interface (UI) of the UE within a time period of less than 10 milliseconds (ms) after a user activates the UI.

17. The apparatus of claim 14, wherein the one or more processors are configured store data link information for APs that have a received signal strength indicator (RSSI) measured at the UE with a power level that is greater than a selected threshold level.

18. The apparatus of claim 17, wherein the data link information comprises a power level of the RSSI, a basic service set identifier (BSSID), security information, and signal band of the APs that have the RSSI with the power level that is greater than the selected threshold level.

19. The apparatus of claim 14, wherein the one or more processors are further configured to send the one or more of the scan results of the APs from the Wi-Fi radio to the AOP of the UE via a system power management interface (SPMI) connection between the Wi-Fi radio and the AOP.

20. The apparatus of claim 19, wherein the one or more processors are further configured to:
perform an update of a Wi-Fi user interface (UI) of the UE comprising:
send a request, from the UI, for a basic service set identifier (BSSID) from the AON DB for the one or more APs of the APs operating adjacent to the UE;
receive one or more service set identifiers (SSIDs) for the BSSID from a memory cache of the UE; and
display the one or more SSIDs in the Wi-Fi UI to enable a user to select an SSID of an AP for the UE to form a Wi-Fi data link with.
